(19) United States
(12) Patent Application Publication
(10) Pub. No.: US 2015/0213486 A1
(43) Pub. Date: Jul. 30, 2015

(54) Method and Device For Placing Branded Products As Advertisements Within Media

(71) Applicants: Gary Shenk, Seattle, WA (US); Mark Owens, Pacific Palisades, CA (US); Jeffrey Bertrand, Seattle, WA (US); Parick Mair, Seattle, WA (US); Richard Frank Garber, Kirkland, WA (US)

(72) Inventors: Gary Shenk, Seattle, WA (US); Mark Owens, Pacific Palisades, CA (US); Jeffrey Bertrand, Seattle, WA (US); Parick Mair, Seattle, WA (US); Richard Frank Garber, Kirkland, WA (US)

(73) Assignee: CORBIS CORPORATION, Seattle, WA (US)

(21) Appl. No.: 14/136,906

(22) Filed: Dec. 20, 2013

Related U.S. Application Data
(60) Provisional application No. 61/746,976, filed on Dec. 28, 2012.

(51) Int. Cl. G06Q 30/02

(52) U.S. Cl. CPC G06Q 30/0246; G06Q 30/0249; G06Q 30/0269

(57) ABSTRACT

Embodiments are directed towards providing a computer-implemented method for integrating or placing branded product advertisement within media, including maintaining by a placement server a database of placement opportunities, receiving from a buyer computer a media plan by a buyer, the media plan specifying desired placements to purchase and a budget, projecting the number of impressions the purchased placements will generate, initiating execution of the media plan, gathering data about the results of each of the purchased and produced placements, determining a placement quality ranking for each placement and estimating a media value for each placement.

### TECHNICAL FIELD

Various embodiments generally relate to a system for placing product advertising within media and assessing the results of a campaign of placements. Included is a method for estimating the value of a product placement based on viewership and other data collected about the media in which the placement was made.

### BACKGROUND

Product placement refers to the placement of product and brand advertising integrated within media such as movies, television programs, songs, Web photos and videos and the like such that the advertising is integrated within the media. Thus, unlike traditional advertising, product placements do not disrupt the continuity of the media. Examples include an actor holding a specific beverage product in a movie where the beverage product's label is prominently featured, an actor driving a specific type of car within a television program, a song that mentions a specific product, or a photo of a celebrity published on a Web page in which the celebrity is wearing a specific brand of clothing. Product placement is a form of advertising but is different from conventional advertising and is not addressed by existing computer-based advertising systems, tools and platforms.

While pricing of advertisements that appear in different channels such as television, radio and web pages, is well understood, little research has been performed to determine how to price product placements that appear in these various channels. Typically, conventional advertising such as television, radio and Web ads are purchased by a media buyer from a rate card or rate sheet that specifies the price of various types of spots for a given channel. For example, television advertisements are often sold on a run of schedule (ROS) basis in which a television ad runs a specified number of times during a fixed time period, say from 6 AM to 6 PM. The price for 1 ROS may depend on the shows the ad appears in or the times of day, but all the variables are known and fixed in advance when the buyer commits to purchasing the advertising.

In contrast, with placements there are many unknowns when a buyer commits to a placement campaign. For example, the quality of a placement may not known before the specific show or media vehicle is created. For example, while a TV script may indicate that an actor may pick up a beverage and hold it for 30 seconds with the label facing the camera, during filming some elements may change and the beverage may be held for only 10 seconds, facing away from the camera. Obviously, in such a case a buyer would expect to pay less for the placement since it would have less impact.

Thus it would be advantageous to provide an automatic method for estimating product placement prices in advance and to calculate an attained media value based on actual placement results.

Thus, it is with respect to these considerations and others that the present invention has been made.

### SUMMARY OF THE DESCRIPTION

Various embodiments are directed towards a product placement system that enable a media buyer to interactively specify a placement campaign for the integration or placement of branded products within media such as movies, videos, songs, and celebrity photos and videos based on estimated prices for placements. Next, the placement system obtains audience measurements and other data about media in which placements were made and estimates the value of the placements. The placement system assesses actual results for a placement campaign based on a placement media plan

Embodiments are directed towards providing a computer-implemented method for forecasting the price of media plan, including maintaining by a placement server a database of placement opportunities wherein a placement opportunity is a segment within a media program in which a branded product may be displayed, and receiving from a buyer computer a specification of a media plan, the specification identifying at least one target market segment and at least one media channel in which to place branded product placements, generating a media plan that includes a plurality of opportunities that are matched to the at least one target market segment and to the at least one media channel, forecasting a price for each placement opportunity included in the media plan, and providing an aggregate price for the media plan to the buyer computer for display to a media buyer.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a generalized block diagram of a preferred embodiment of an online product placement system in which a product placement service enables a media buyer, or user to specify a media plan, and which then executes the media plan.

FIG. 2A illustrates one embodiment of a user interface that enables a buyer to specify requirements for a product placement media plan.

FIG. 2B illustrates one embodiment of a user interface that enables a buyer to specify a channel mix for a product placement media plan and to interactively select and reject product placement opportunities provided by a product placement system.

FIG. 2C illustrates a one embodiment of a user interface that enables a buyer to filter product placement opportunities provided by a product placement system.

FIG. 2D illustrates one embodiment of a user interface for a media buyer that summarizes a product placement media plan.

FIG. 2E illustrates one embodiment of a user interface that projects the results that will be achieved when a placement campaign based on a specific media plan is executed.

FIG. 2F illustrates one embodiment of a user interface that summarizes the results of multiple placement campaigns where each placement campaign is based on a media plan specified by a buyer.

FIG. 2G illustrates one embodiment of a user interface that summarizes the results of a single placement campaign based on a media plan.

FIG. 2H illustrates one embodiment of a user interface that summarizes the results of a placement campaign based on a media plan from placements within a single media channel.

FIG. 3 provides an overall flowchart of the steps performed to define a product placement media plan, project results, perform a placement campaign based on the media plan, gather results data and assess the results of the campaign.

FIG. 4 is a flowchart of one embodiment of a method for projecting product placement results for a media plan.

FIG. 5 is a flowchart of one embodiment of a method for estimating the media value of placements that have been made.

FIG. 6 depicts a pricing model, referred to herein as a media value matrix, that is used to estimate the value of a placement based on three key factors.

FIG. 7 is a system diagram that shows components of one exemplary environment in which the invention may be practiced.

FIG. 8 is block diagram of the exemplary software modules of a product placement server.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Impression—refers to a viewing or listening of a piece of media such as a movie, television program, Web video, song, or photo by one person.

CPM—refers to a standard cost metric that means the price charged by a publisher for a conventional advertisement or placement in a piece of media for one thousand impressions or views.

Channel—as used herein refers to a category of media in which a product placement can be made. Channels include television, movies, music, printed advertisements, Web video advertisement, Web image advertisements, and the like.

Media Vehicle or vehicle—refers to a specific piece of media such as a specific television program, film, video, song or other piece of media in which a product placement may be made.

Vehicle power—refers to a rating of the intrinsic value of a particular vehicle piece of media to a media buyer, for example a TV program, a film, etc. This can be determined by factors such as the viewership of the vehicle, cast, director, buzz, etc. It may be noted that CPM for conventional advertising in television programs doesn't always correlate to the program's viewership. This may be due to the fact that some shows attract higher value demographics than others and hence receive a higher CPM even when it has a smaller audience. In one embodiment vehicle power is stated as a letter value, e.g. A, B, or C where A refers to vehicles that have more value, and are thus more costly to advertise in and C refers to vehicles that have more value and thus are less expensive to advertise in.

Branded product placement, product placement or placement—means the integration of a display, appearance, or mention of a product or brand within a vehicle. The media may be audio or visual, or both, such as within a music video. A placement is different than a conventional advertisement in that it is integrated with the media content, i.e. there is continuity between the media content of the vehicle and the placement. Thus, the storyline of the vehicle is not disrupted and the viewer does not perceive a placement as a separate advertisement. For example, a viewer can choose not to watch a commercial inserted into a television program and not miss the program content itself. Integration of a product placement into a vehicle means that if the viewer doesn't see the placement they miss viewing or listening to at least a portion of the vehicle content. The term product placement refers to advertisements for specific products as well as to more general advertisements for brands, e.g. when a company logo might appear rather than a specific product. Examples of placements include an actor in a movie driving a specific model of car during a chase scene, an actor holding a specific, easily recognizable beverage, in a movie, film, or photo, or a mention of a specific product in a song. Pricing of placements has not previously been standardized in the way that pricing for conventional advertisements have. Thus, creating a model and an automated method for estimating the value and hence price of a placement is itself novel and unique.

Another important difference between a placement and a conventional advertisement is that the advertiser creates an advertisement and control over every aspect, for example the content, and duration. Typically, a placement is purchased by a media buyer prior to its being created; and it is created as part of the creation or production of the vehicle itself.

Product placement opportunity, or opportunity—means a potential placement in a vehicle that may be purchased by a media buyer.

Placement quality—refers to a rating of the relative importance or prominence of a brand or product placed within a vehicle. Factors used to assess placement quality include prominence of the item. For example, if the placement is for a soft drink in a TV show, if the soft drink is prominently displayed in the hands of a major star then the placement quality would be very high; on the other hand, if the soft drink is on a table in the corner then the placement quality would be low. Another factor that may be used to assess placement quality is the treatment of the item. For example, if the placement is for a particular brand of coffee, do the actors in the scene appear to be enjoying the coffee? Another factor is whether the placement is integrated into the storyline of the vehicle. Yet another factor is whether there is a verbal or nonverbal mention of the product in the vehicle. In one embodiment placement quality is specified using a scale of Premium, Prominent and Standard where Premium is the high quality placement and Standard is a low quality placement.

While vehicle power may be assessed before a placement is made, the placement quality can only be evaluated after a placement has been produced, or created, and is integrated into a vehicle since many of the criteria used to evaluate placement quality, e.g. visibility of product, are under the control of the producer or director of the vehicle and cannot be known in advance of production. Note that as used herein the terms “creation” and “production” are used synonymously and refer to the process of creating a media vehicle such as a movie, typically using digital media tools for creating media such as film and video editors and sound mixers.

Placement duration or simply duration—refers to the amount of time during a media segment, e.g. during a film or TV show or song, that a placement occupies. For example, if a placement consists of an actor holding a can of soda in a film the duration would be the length of time in which the actor appears holding the can of soda. Similar to placement quality, the duration of a placement can typically only be evaluated after a vehicle in which a placement appears has been produced since decisions affecting the duration of a placement are made during production.

Media buyer or buyer or user—means an individual that uses a mobile device, PC or other electronic device to access and use a product placement service available across a network, typically with the objective of specifying a media plan or evaluating results from implementation of a media plan by the placement service.

### Generalized Operation

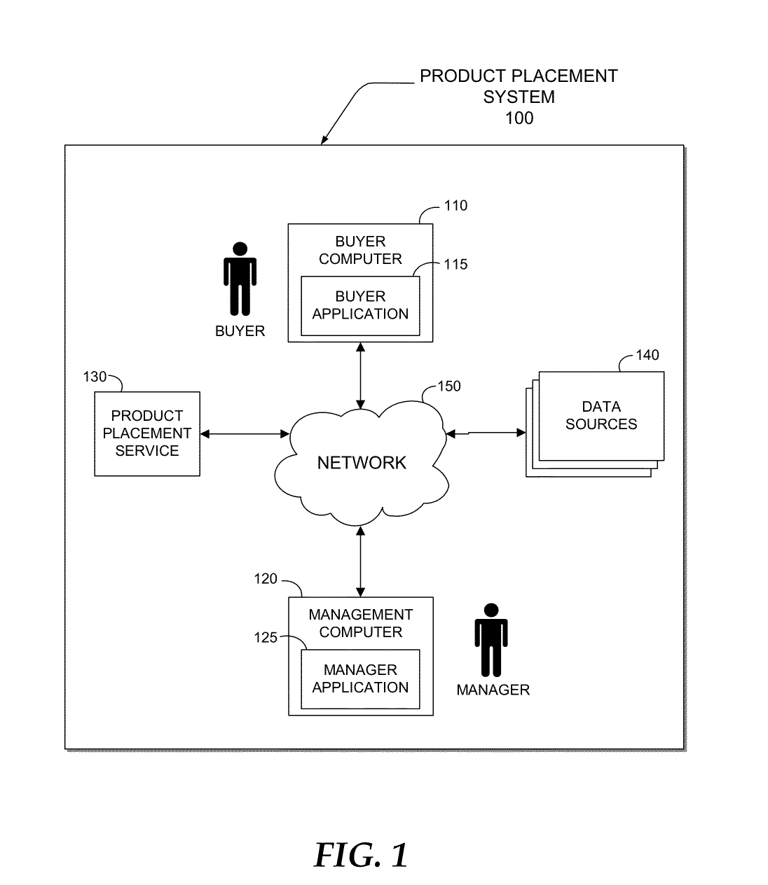

The operation of certain aspects of the invention is described below with respect to FIGS. 1-8.

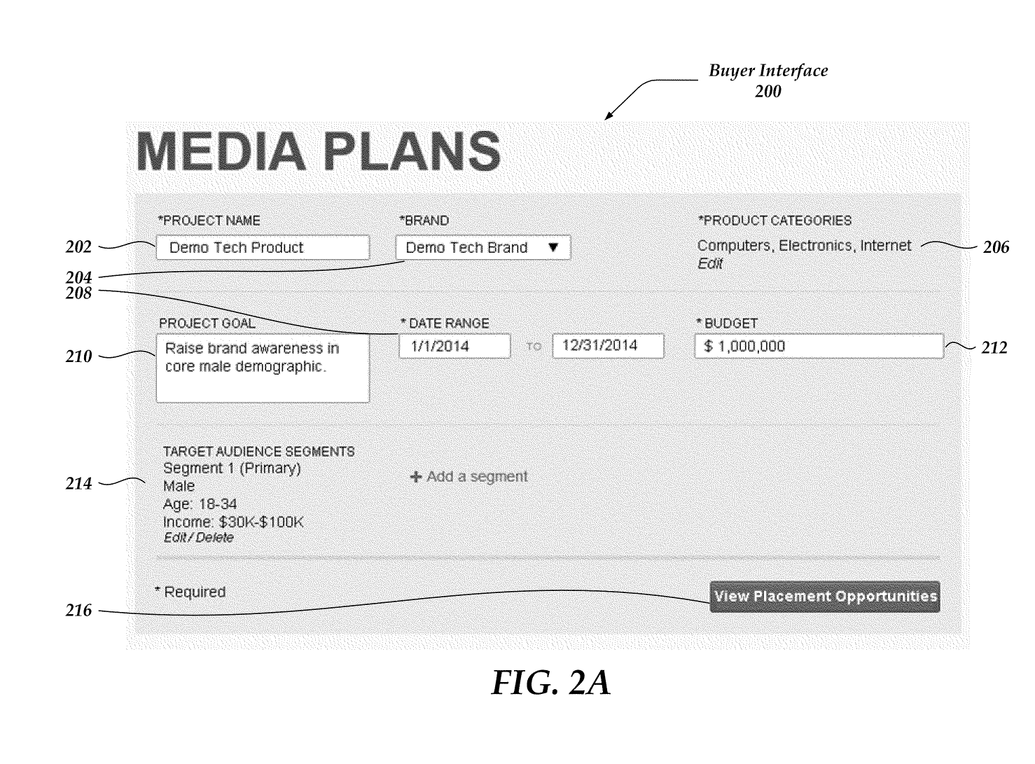

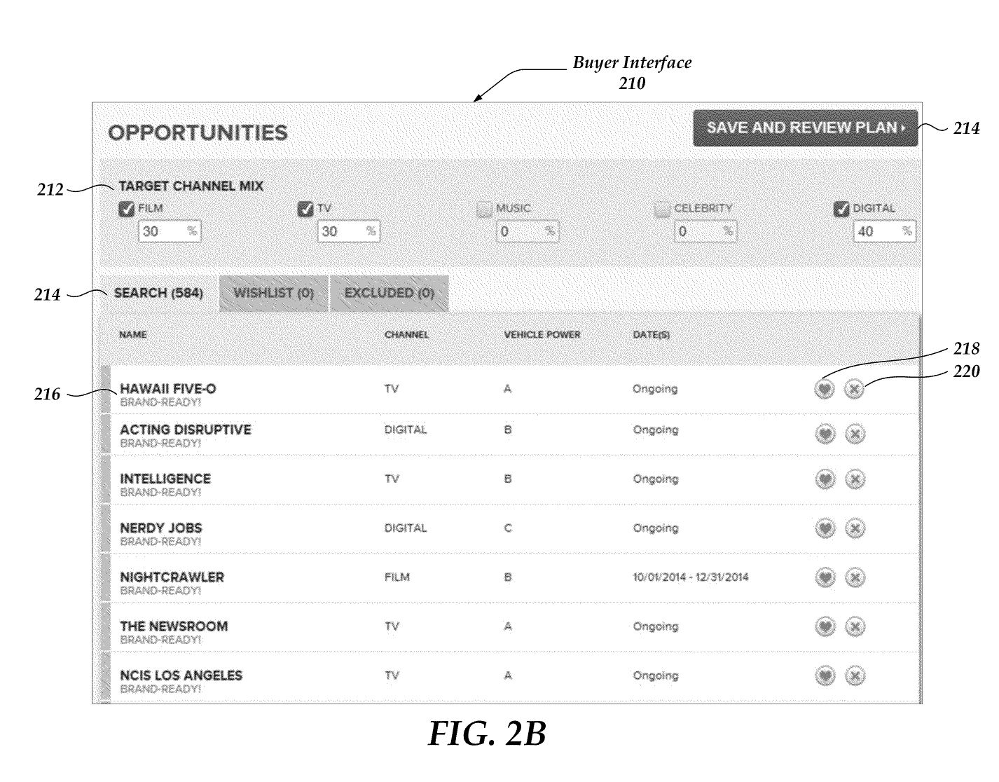

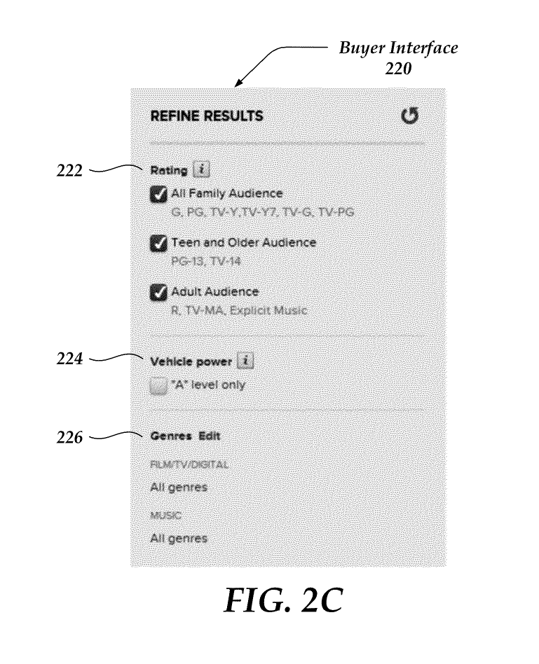

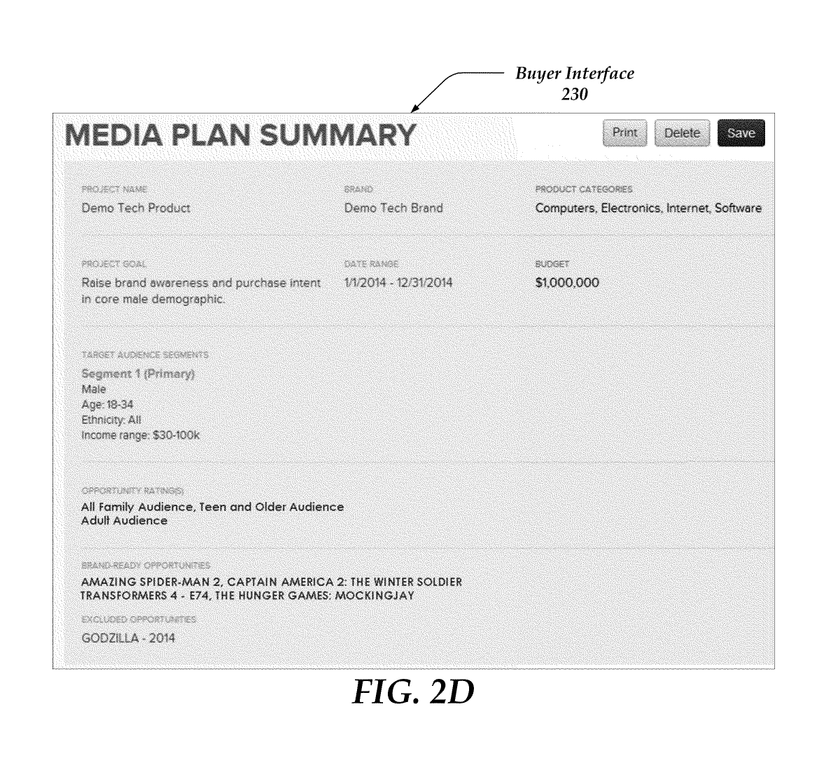

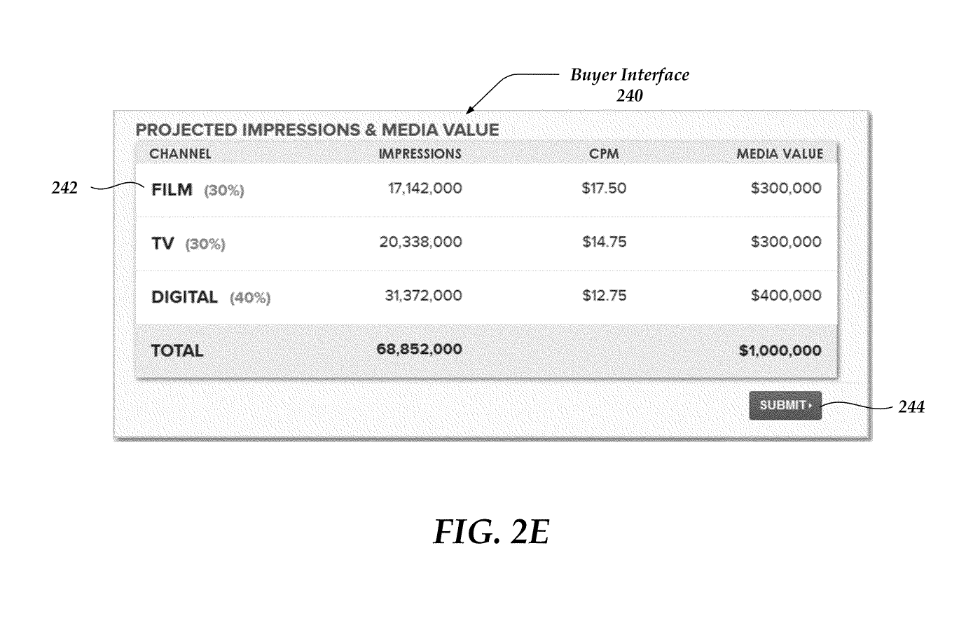

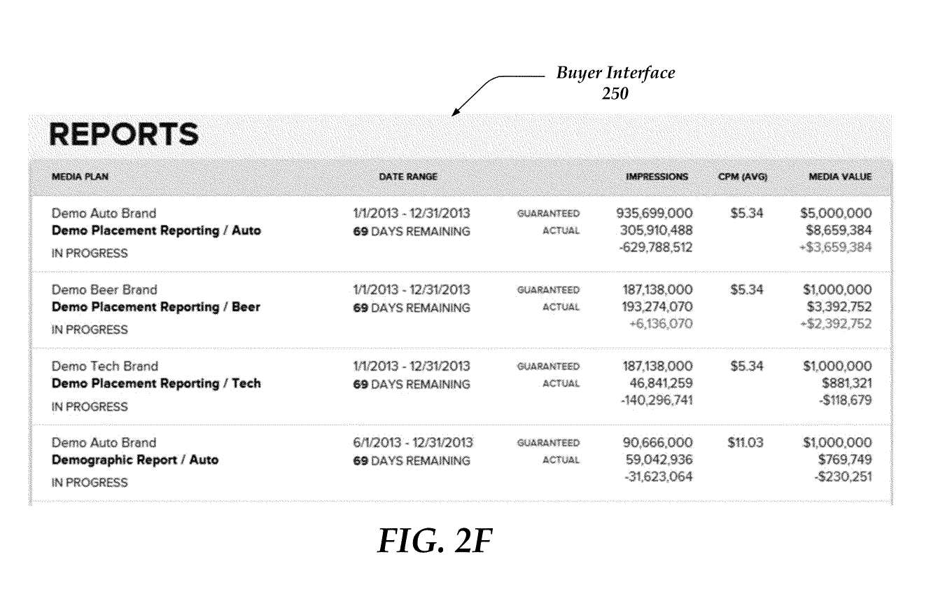

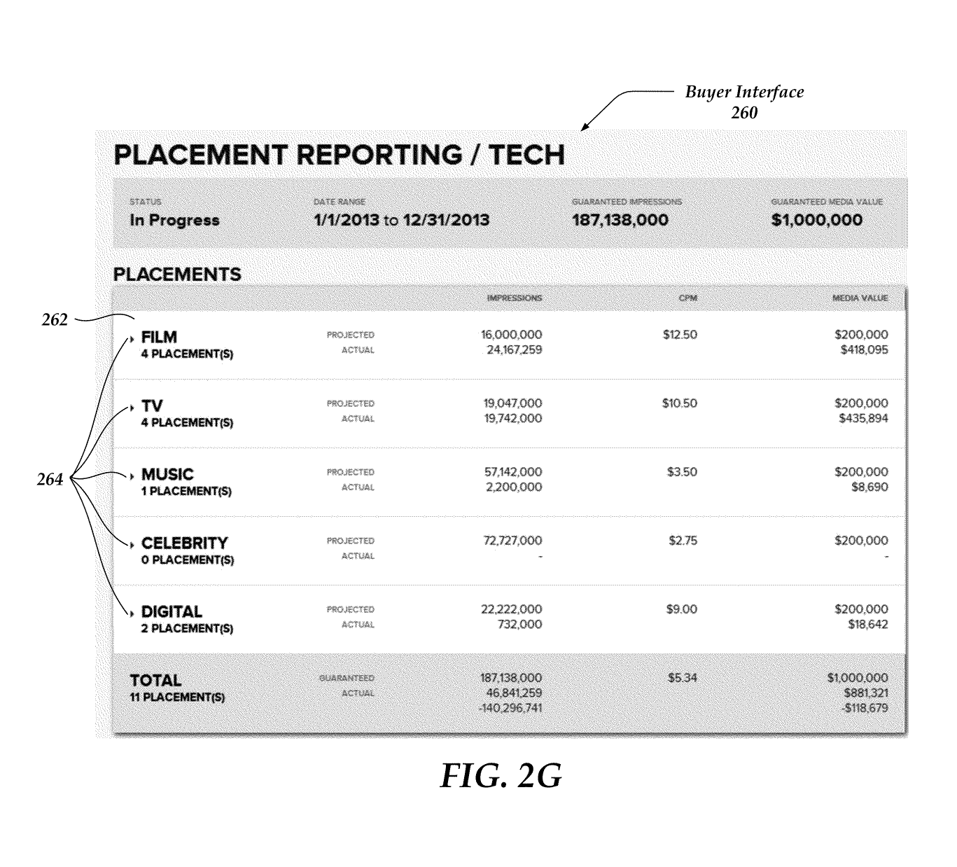

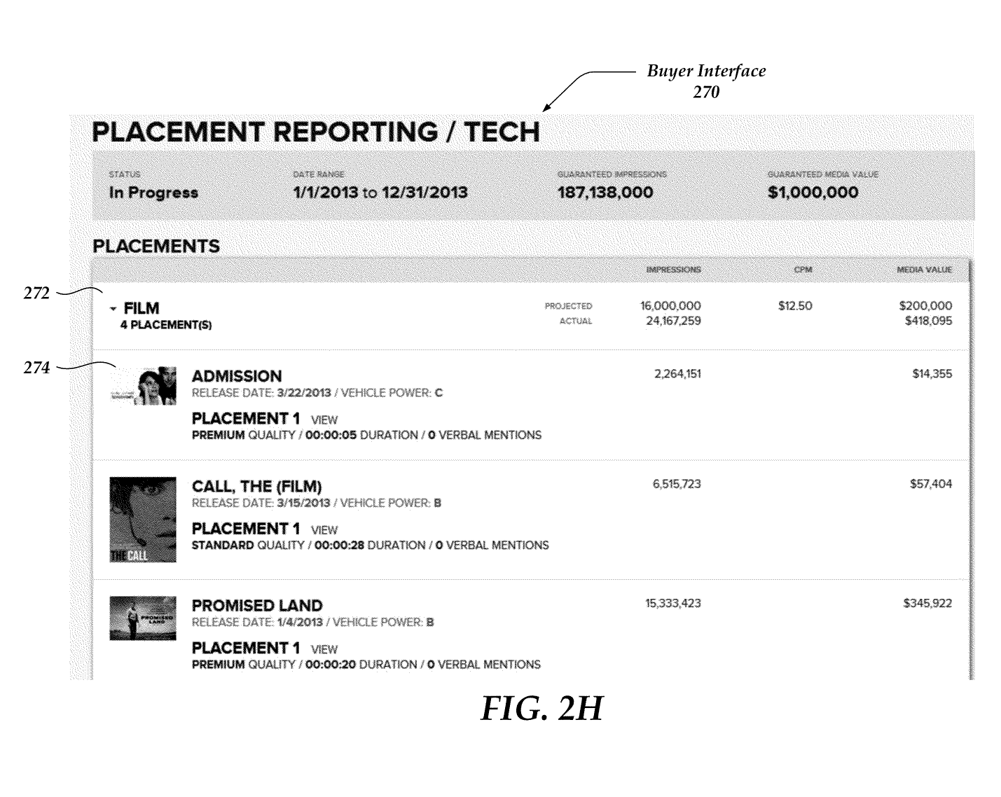

FIG. 1 is a generalized block diagram of a preferred embodiment of an online product placement system in which a product placement service enables a media buyer, or user to specify a media plan, and which then executes the media plan. A media buyer, hereinafter referred to simply as a buyer or user, uses a buyer application 115 that runs in a buyer computer 110 to perform some or all of the following functions: specify, define, edit or modify a media plan, specify filters, and view summary and detailed results from execution of a media plan. Customer application 110 is described in further detail hereinbelow with reference to FIGS. 2A-H. Buyer application 115 may be a HTML script that is downloaded from a product placement service 130 and executed by a Web browser that runs in buyer computer 110 or it may be an application that is separately downloaded or installed from other media such as a CD ROM or DVD into buyer computer 110 for execution by a buyer.

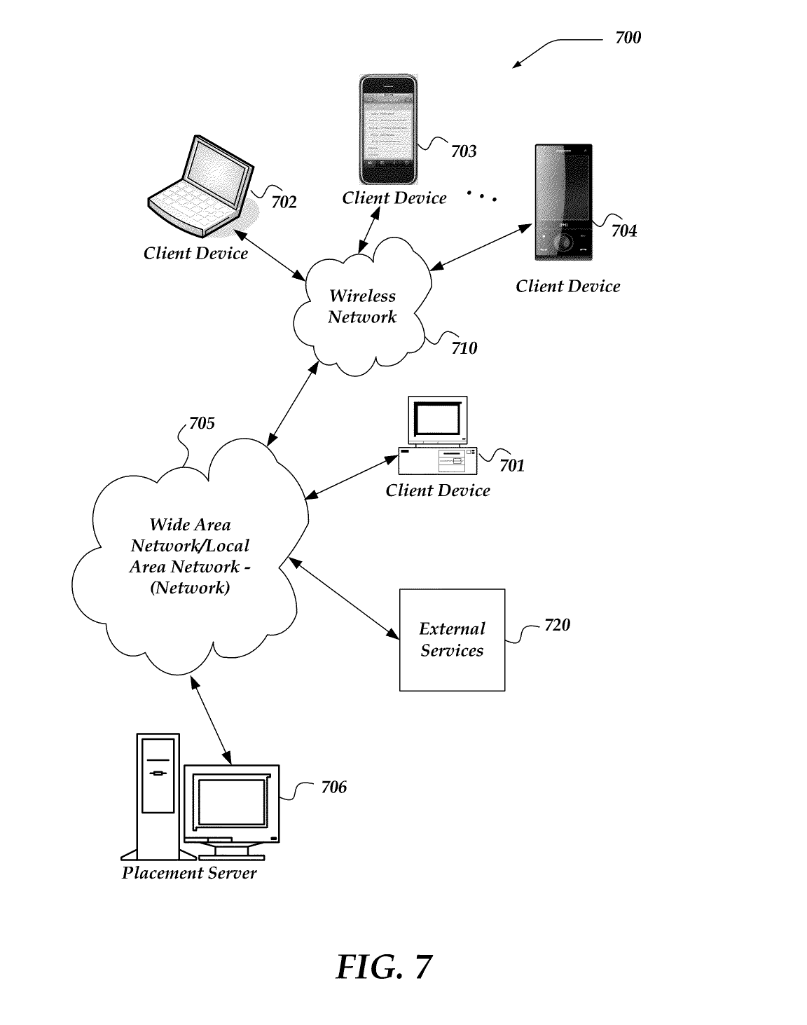

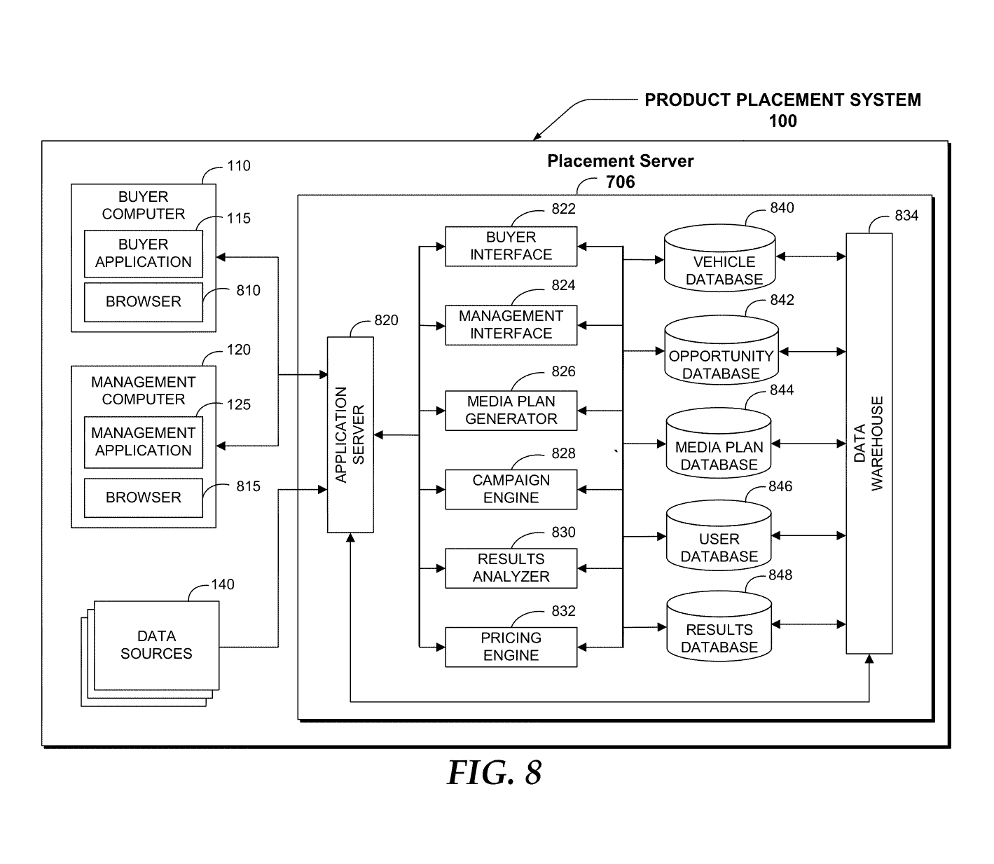

Product placement service 130 refers to a service that is available across a network 150. Product placement service 130 may be implemented by one or more server computers acting cooperatively or by a network service, or “cloud” service provided by a third party. One embodiment of a server-based approach to implementing product placement service 130 is described hereinbelow with reference to FIGS. 7 and 8. Placement service 130 provides services across network 150 to buyer computer 110 and to a management computer 120.

A manager of placement service 130 ensures that placement opportunities are available to a buyer using buyer application 115 running on buyer computer 110. A manager uses a management application 125 that runs inmanagement computer 120 to interact with management functions provided by product placement service 130. Management functions may include determining and entering vehicle power values for opportunities, determining and entering placement quality values for placements after they have aired and maintaining a database of buyers with up-to-date buyer information.

Product placement service 130 maintains a database of product placement opportunities, also referred to herein simply as opportunities. Each opportunity refers to a potential product placement within a vehicle such as a television program, song or movie. Once an opportunity is included in a media plan and executed as part of a placement campaign it is referred to as a placement or product placement.

Typically, information about a vehicle or opportunity is obtained from external data sources 140. Data sources 140 may be publically available databases or services or private information services. Table 1 below, gives an example of data that may be obtained from data sources 140 for different channels. This information is available from a variety of companies and organizations including, for example, THE NIELSEN COMPANY, COMSCORE, and GOOGLE.

TABLE 1
Example external data sources

| | Type of Data Available From |
|---|---|
| Channel | External Data Sources |
| Film (movies) | Number of impressions per |
| | geographic territory; |
| | demographics of audiences. |
| Television | Impression counts; |
| | demographic profiles for |
| | impressions. |
| Digital (video accessed | Impression counts and |
| across the Internet, | demographics of viewers. |
| includes video ads in | |
| Web pages as well as | |
| video shows) | |
| Music Video | Impressions and demographics |
| | of viewers. |
| Celebrity Image for | Publication in which celebrity |
| Print Media | seeded images are published; |
| | average circulation of each |
| | publication and demographic |
| | profile of viewers. |
| Celebrity Images for | List of URLs that identify Web |
| Web Media | pages that publish seeded |
| | celebrity images; impressions |
| | and demographics of viewers. |

FIGS. 2A-H are embodiments of a user interface implemented by buyer application 115. In one embodiment, each of FIGS. 2A-2D correspond to an interactive Web page that is provided by placement service 130 to buyer computer 110 to be displayed by buyer application 115.

FIG. 2A illustrates one embodiment of a user interface that enables a buyer to specify requirements for a product placement media plan. Buyer interface 200 includes entry box 202 that enables the buyer to specify a project name, pull down menu 204 that enables the buyer to specify a brand or product line or company, entry box 210 that enables the buyer to enter a project goal, and date boxes 208 that enable the buyer to specify a date range, depicted as a starting date and ending date, for the campaign that executes the media plan. In addition, buyer interface enables the buyer to specify product categories 206, and a campaign budget 212. A set of segment controls 214 enable a buyer to specify the market segments to be addressed in the media plan. Segment information that may be specified include gender, age, geography, income, occupation, buying preferences, race, nationality and the like. Multiple market segments may be defined as target segments using segment controls 214.

When a user finishes specifying the information requested in buyer interface 200, he/she presses a control 216 to indicate the placement service 130 that he/she is finished. The media plan information is then transmitted by buyer computer 110 to placement service 130 for further processing.

FIG. 2B illustrates one embodiment of a user interface that enables a buyer to specify a channel mix for a product placement media plan and to interactively select and reject product placement opportunities provided by a product placement system. In response to the media plan inputs provided by a buyer using buyer interface 200, placement service 130 identifies and provides a list of available opportunities to buyer computer 110 for display to the buyer. Buyer application 115 provides buyer interface 210 to the buyer, which enables him/her to view and further refine opportunities selected for inclusion in the media plan. A channel mix control 212 enables the buyer to specify the percentage of the budget to allocate to each media channel. While the channels illustrated in this example embodiment include film, TV, music, celebrity and digital (i.e. Web media), other channels may be included or channels illustrated may be omitted without departing from the scope and spirit of the subject invention. If the buyer un-checks the checkbox next to a channel then no budget is allocated to this channel. Further, in some embodiments the percentages may reflect a target percentage of impressions, rather than a percentage of budget to allocate to each channel. Using controls 214 the buyer can view opportunities that have been added to a wishlist or an excluded list. In this embodiment, an opportunity list 216 displays a list of opportunities identified by placement service 130 as being consistent with the media plan specified by the user and available for placements. Additionally, the buyer can perform keyword searches to select individual opportunities or groups of opportunities for inclusion or exclusion in the media plan. Two controls are available for each opportunity. An include control 218 enables the buyer to indicate that he/she wants to include the opportunity and similar opportunities in the media plan. Included opportunities are added to the wishlist. An omit control 220 enables the buyer to indicate that he/she wants to omit the opportunity and similar opportunities from the media plan. Omitted opportunities are added to the excluded list. In other embodiments, include control 218 is used to indicate that a specific opportunity should be included and omit control 220 is used to indicate that a specific opportunity should be excluded. When the buyer completes selecting opportunities he/she uses a save control 214 to indicate that their opportunity processing is complete.

FIG. 2C illustrates a one embodiment of a user interface, referred to as buyer interface 220, that enables a buyer to filter product placement opportunities provided by a product placement system. In addition to the controls described with reference to FIG. 2B, a set of refine controls are provided to the buyer by buyer interface 220. Using a rating control 222 a buyer may select a not-to-exceed rating level. In this example the ratings correspond to those defined by the Motion Picture Association of America, and are categorized as All Family Audience, Teen and Older Audience, and Adult Audience. A vehicle power control 224 enables the buyer to specify the vehicle power levels that should be excluded; in the example depicted the control enables the buyer to specify that only ‘A’ level placements should be included in the media plan. A genre control 226 enables the buyer to select one or more genre's to include or exclude from the media plan. A list of genres specific to each type of media, e.g. film, TV music, is typically available for selection by the buyer.

In other embodiments additional refine controls are available to the buyer. For example, an exclude control may be provided that enables a buyer to specify genres of placements to exclude. For example, the user may specify that opportunities that depict or suggest drug use should be excluded.

FIG. 2D illustrates one embodiment of a user interface, referred to as buyer interface 230, for a media buyer that summarizes a product placement media plan. Buyer interface 230 presents information that summarizes the media plan that was interactively specified by the buyer using buyer interfaces 200, 210 and 220.

FIG. 2E illustrates one embodiment of a user interface, referred to as buyer interface 240, that projects the results that will be achieved when a placement campaign based on a specific media plan is executed. In a display panel 242, Buyer interface 240, displays, for each channel in the media plan, the impressions, CPM and budget allocated to purchasing the placements included in a media plan, referred to as the media value. The data displayed by buyer interface 240 is calculated and provided by placement service 130. The total cost of $1,000,000 matches the budget specified by the buyer using buyer interface 200. FIG. 2E may be provided as part of a dashboard, i.e. a user interface that enables a buyer to see key information at a glance.

Using a submit control 244, the buyer may submit the media plan to placement service 130 for execution. In this case, placement service 130 performs a placement campaign as specified by the submitted media plan. Thus, each placement campaign performed by placement service 130 corresponds to a previously submitted media plan.

FIG. 2F illustrates one embodiment of a user interface, referred to as buyer interface 250, that summarizes the results of multiple placement campaigns where each placement campaign is based on a media plan specified by a buyer. For each media plan submitted by a buyer to placement service 130 for execution, buyer interface 250 displays projected values and actual values for key results for the corresponding placement campaign. In this example embodiment, for each media plan the date range and days remaining are listed together with aggregate values across all media channels for the projected, or guaranteed number of impressions, CPM, and media value. Actual aggregate results are given for the number of impressions achieved thus far and the corresponding media value. The media value is defined as the actual cost of purchasing the product placements that generated the impressions as shown. In one embodiment, a market value is also provided where market value is the cost of purchasing comparable conventional advertisements rather than placements. In the row entitled “IN PROGRESS”, the difference between the projected and actual impressions and the projected and actual media value is given. In this embodiment, the budget specified by the buyer is given as the projected media value. Further, the term guaranteed is used to indicate that a placement campaign is guaranteed to achieve the projected number of impressions calculated for the corresponding media plan and that the media value achieved is guaranteed to meet or exceed the budget specified by the buyer, as given in FIG. 2E. In another embodiment, only the number of impressions are guaranteed, while in yet another embodiment only the media value is guaranteed.

FIG. 2G illustrates one embodiment of a user interface, referred to as buyer interface 260, that summarizes the results of a single placement campaign based on a media plan. Buyer interface 260 includes a delivery and impact panel 262 that displays campaign results for each channel included in the media plan. Similar to buyer interface 250, buyer interface 260 displays results information including the number of projected and actual impressions achieved for each channel, the projected CPM, and the projected and actual media value. Additional detail about each channel may be obtained by selecting a more detail control 264 that appears to the left of the name of each channel.

FIG. 2H illustrates one embodiment of a user interface, referred to as buyer interface 270, that summarizes the results of a placement campaign based on a media plan from placements within a single media channel. Buyer interface 270 includes a channel panel 272 for each media channel in the media plan. Channel panel 272 includes a placement panel 274 for each placement made within the channel. In the example illustrated in buyer interface 270 four film placements were made (of which only 3 are shown in FIG. 2H). The first placement, in the film entitled “Admission” has a vehicle power of C, and the placement itself was premium quality, 5 seconds in duration, with no verbal mentions (of the product being placed). The placement generated 2,264,151 impressions and had a media value of $14,355.

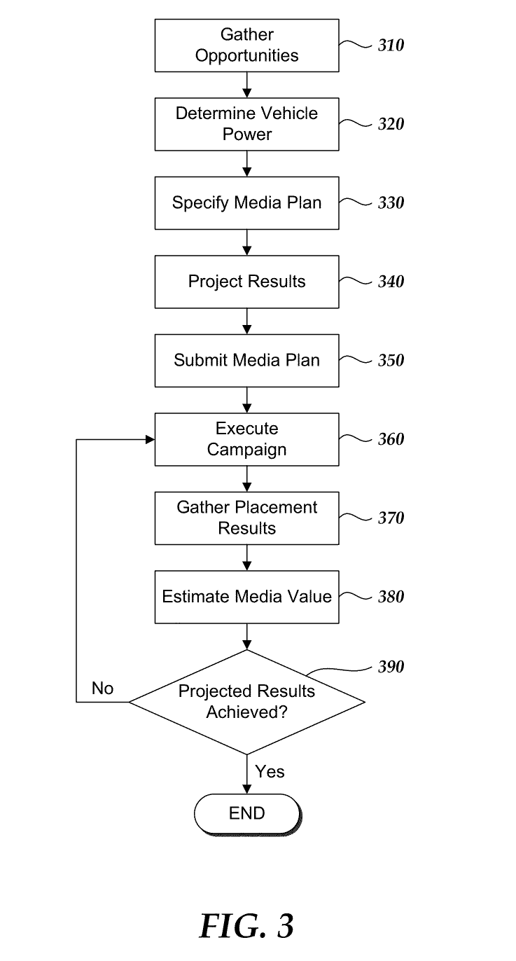

FIGS. 3-5 and 7-9 are flowcharts and component diagrams in which each graphical element, including rectangles, cylinders, and triangles, can be implemented by computer program instructions. These program instructions may be provided to a processor and then executed by the processor, thus creating means for implementing the actions represented by the graphical element. The computer program instructions may be executed by a processor to cause a series of operational steps to be performed by the processor to produce a computer-implemented process such that the instructions, which execute on the processor to provide steps for implementing the actions represented by the graphical element. Some of the computer program instructions may be performed in parallel, or across more than one processor, such as might arise in a mufti-processor computer system. In addition, the actions represented by one or more graphical elements may also be performed concurrently with actions represented by other graphical elements, or even in a different sequence than illustrated without departing from the scope or spirit of the invention. It will also be understood that the actions represented by each graphical element and by combinations of graphical elements can be implemented by special purpose hardware-based systems that perform the specified actions or steps, or combinations of special purpose hardware and computer instructions.

FIG. 3 provides an overall flowchart of the steps performed to define a product placement media plan, project results, perform a placement campaign based on the media plan, gather results data and assess the results of the campaign. The method commences at step 310 when placement service 130 gathers a plurality of placement opportunities and stores them such that they can be interactively searched and browsed by a buyer using buyer computer 110. As part of this step, information about the vehicles in which placements can be made is also collected and stored. Typically, this step is performed continuously, thus the databases of opportunities and vehicles, described further hereinbelow with reference to FIG. 7, are continuously updated.

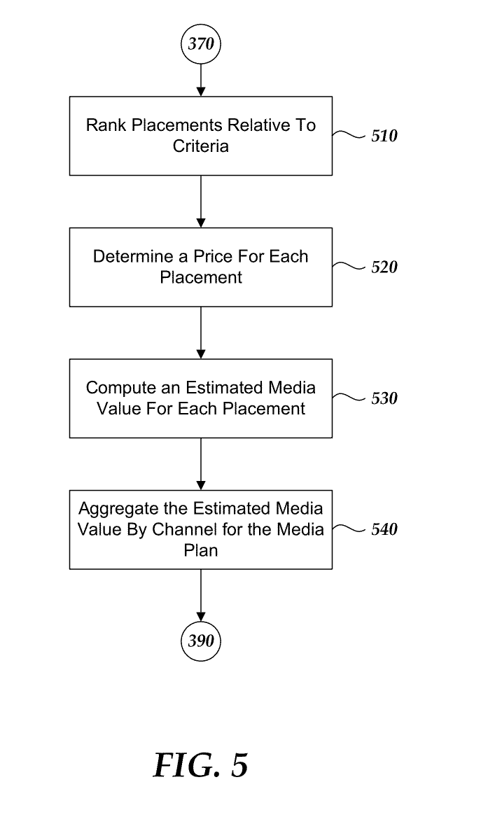

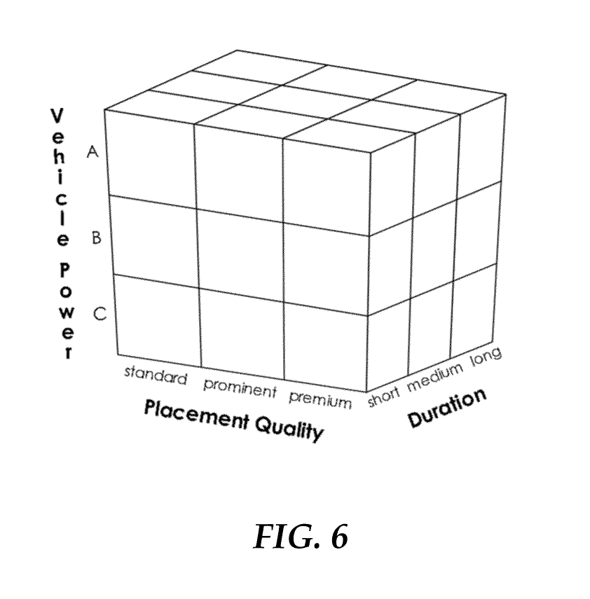

At step 320 a vehicle power ranking is determined for each vehicle in which an opportunity is available. Further information about vehicle power and a method for determining a vehicle power ranking is described hereinbelow with reference to FIGS. 5 and 6. In this embodiment, a vehicle power ranking, which is a measure of the relative value of a vehicle to a media buyer or advertiser, is determined prior to the occurrence of a placement in the vehicle. In other embodiments vehicle power may be re-evaluated after a placement is made in a vehicle and its viewership results are obtained.

At step 330 when a media buyer uses a user interface, also referred to as a buyer interface or buyer user interface, such as those depicted in FIGS. 2A-E, to interactively specify a product placement media plan. As part of this step, placement service 130 provides a list of placement opportunities consistent with the media plan being specified to a buyer. Further, as the buyer refines the media plan using searching, filters and other tools, placement service 130 updates the list of opportunities presented to the buyer. As described with reference to FIG. 2B the buyer can select placement opportunities to add to his/her wishlist and exclude individual opportunities or categories of opportunities.

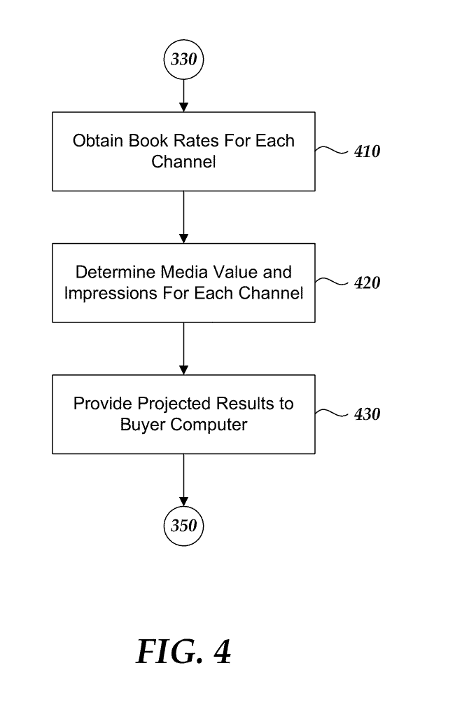

At step 340 placement service 130 projects the results of the media plan. Typically the forecast includes a forecast of the number of impressions that will be achieved, for each of the channels included in the media plan, when the media plan is executed. This forecast may be displayed using a user interface such as buyer interface 240 depicted in FIG. 2E. This step is described in further detail with reference to FIG. 4. In a preferred embodiment, this projection is equivalent to a guarantee to a buyer that a placement campaign performed by placement service 130, based on a corresponding media plan previously submitted to placement service 130, will achieve the projected results. There may be contractually agreed upon penalties if the guaranteed results are not achieved. In another embodiment, the projected results are equivalent to an estimate and have no contractual significance.

At step 350, when the buyer is satisfied with the media plan, he/she submits it to placement service 130 for execution. Typically, a Web service is used by buyer computer 110 to submit the media plan to placement service 130. And conversely, typically product placement service 130 uses a Web service to receive the submitted media plan from buyer computer 110.

At step 360 placement service 130 executes a placement campaign in accord with the previously submitted media plan. The time period over which the campaign takes place is defined in the media plan itself and may last from several days to several months. In some embodiments, execution of the media plan is performed entirely automatically by server computers that implement placement service 130 by automatically purchasing placements. In other embodiments, placement service 130 specifies the various elements of the placement campaign and some of those elements, such as the purchase of product placements are performed by persons and/or organizations specialized in making such media purchases. In yet other embodiments, execution of the placement campaign is performed by a combination of server computers, individuals and organizations.

At step 370, placement service 130 gathers the results of the placement campaigns in progress and populates one or more databases with results data. In particular, results data is obtained for each placement that has been executed as part of the campaign and for each vehicle in which a placement has been made. Results data includes the number of impressions generated by each vehicle in which a placement was made and the demographics of viewers of each vehicle. In addition, the vehicle itself or a link to it, e.g. a song or movie, may be obtained and the placement may be clipped or excerpted for further analysis or for viewing.

At step 380 placement results data gathered in the preceding step is processed or assessed to determine the media value for each placement. This step is further described with reference to FIG. 5, hereinbelow. In one embodiment, this step includes determining a placement quality ranking and a duration for each placement. In addition, tabular reports such as those illustrated in FIGS. 2F-H may be generated. In some embodiments, periodic reports are printed and emailed or mailed to the buyer. In other embodiments, a final report may be produced, which includes additional information, and provided to the buyer. This step may be performed on an ongoing basis during execution of the media plan. This step may be performed for a specified period of time after the conclusion of the placement campaign.

At step 390 a determination is made as to whether the guaranteed project results have been met. If so, the method terminates. If not, then the campaign continues at step 350 and additional placements are made. In one embodiment, the guaranteed results are met when the projected number of impressions have been reached and estimated media value meets or exceeds the projected media value, i.e. the media plan budget. This approach to delivering value to a buyer through product placement is novel and unique. In other embodiments, the guaranteed project results may be met when one of the two conditions, i.e. the guaranteed number of impressions is reached, or when the estimated media value reaches the media plan budget, is met but not both.

### Projecting Placement Prices

FIG. 4 is a flowchart of one embodiment of a method for projecting product placement results for a media plan. Essentially, this one embodiment of a method that performs step 330 of FIG. 3.

At step 410 the book rates, i.e. the term of art for standard prices for advertisements, are obtained for each media channel included in the media plan, where a book rate for a channel is defined as the price in CPM at which impressions for that channel are sold to a buyer. For example, in one embodiment, book rates are specified by a manager using manager application 125 and are stored by product placement service 130. An example of a table stored by product placement service 130 from which book rates are obtained is given below in Table 2.

TABLE 2
Example Book Rates By Media Channel

| Media Channel | Book Rate (CPM) |
|---|---|
| Film | $17.50 |
| TV | $14.75 |
| Digital | $12.75 |

At step 420 the book rate for each channel is used to compute the number of impressions projected for a placement campaign based on the media plan. This projection is based on (1) the budget allocated to the channel by the buyer and (2) the book rate for the channel. Thus, using the CPM values in Table 2 and taking FIG. 2E as an example, if a media plan with a $1.0 million budget is allocated 30% to film, 30% to television, and 40% to digital then 17,142,000 impressions are projected for film, 20,338,000 impressions are projected for television, and 31,372,000 impressions are projected for digital. In a preferred embodiment, as described with reference to FIG. 3, the buyer is guaranteed a media value of $300,000 for film, $300,000 for television and $400,000 for digital. As previously discussed, in one embodiment, execution of a placement campaign continues until the projected media value and the projected number of impressions are achieved. In this embodiment, the projected values serve as guaranteed minimum results.

In certain embodiments, the book rates by be adjusted in this step based on known factors such as the target demographic segmentation and the vehicle power of vehicles specified for inclusion in a media plan.

At step 430 the projected values for a campaign based on the media plan are provided to buyer computer 110 for display to the buyer.

### Estimating Media Value

FIG. 5 is a flowchart of one embodiment of a method for estimating the media value of placements that have been made. The method described hereinbelow implements one embodiment that performs step 370 of FIG. 3, i.e. it estimates the media value that has been achieved by placement service 130 during execution of a placement campaign or after a placement campaign has terminated.

It may be appreciated by one skilled in the art, that there is no standard pricing formula that can be applied to estimate the value achieved by a product placement. While the value of a conventional advertisement can be defined by its price which is typically given in a rate card provided by the seller of the advertising, the value of a product placement cannot be known until after the placement in a vehicle has actually occurred. As previously discussed, this is because the placement is integrated into the media and the parameters of the placement can change substantially during creation of the vehicle, e.g. film, in which the placement occurs. Thus, in the present invention the media value, i.e the value to the buyer, of a placement is estimated using available data that is collected and then assessed after the placement is made. Available data includes the impressions generated by a vehicle, such as a television program that was shown at a certain date and time, and demographic data about the audience for the vehicle. Available data may also include advertising rates for conventional advertisements such as TV ads, radio ads, Web ads.

At step 510 the results data is used to rank the placement relative to a number of factors that are used to estimate media value. In one embodiment, the factors are the media channel, the number of impressions, or viewers, of the placement, the vehicle power, placement quality and duration. In the cases of vehicle power, placement and duration a number of criteria are used to rank each of these factors. The criteria are used to rank or score the placement relative to each factor.

This method of determining a media value for a placement based on a matrix of rankings for three key factors is illustrated in FIG. 6, which depicts a pricing model, referred to herein as a media value matrix. In this embodiment, for a given channel the media value of impressions for a placement is estimated by the values in a 3 dimensional media value matrix, where the three axes are vehicle power, placement quality and duration. The values in each cell are in CPM units; however these are used herein to estimate the media value of impressions rather than to set actual prices. In other embodiments there may be more or less than 3 dimensions in a media value matrix. Further, in other embodiments, the values may be calculated by a mathematical expression or other algorithm rather than taken from a matrix without departing from the scope and spirit of the present invention.

In one embodiment, specific criteria that are used to rank a placement for vehicle power and placement quality are given below, in Table 3.

TABLE 3
Criteria Used To Rank a Placement Relative to Factors

| Factor | Criteria |
|---|---|
| Vehicle Power | Projected Viewership, or actual |
| | viewership of prior vehicles of |
| | the same series or media |
| | franchise |
| | Cast & Director |
| | Network & Timeslot (TV) |
| | Demographics |
| | Buzz |
| | Brand Appropriateness |
| | Heat Index (TV, Celebrity) |
| Placement Quality | Appropriateness & Believability |
| | Hands on Usage (of product |
| | being placed) |
| | Visibility of Product/Logo |
| | Verbal Mention (of Product or |
| | Brand) |
| | Implied Celebrity Endorsement |
| | Positive Brand Message |
| | Integration (of Product or |
| | Brand) with Storyline |

It may be appreciated that several of the criteria listed above in Table 3, such as buzz, and heat index are evaluated and provided by external services while others may be evaluated and entered by managers using management application 125. Vehicle power, or simply vehicle, criteria may be referred to as vehicle criteria in that they are used to evaluate aspects of the vehicle itself, independent of whether a placement is made. Thus, in one embodiment, vehicle power is evaluated prior to a placement being made and the vehicle power ranking for a vehicle may be displayed or otherwise provided to a buyer prior to a placement or media plan being made. In one embodiment, vehicle power is handled similarly with rankings denoted as A, B, or C. In one embodiment, vehicle power is ranked or graded based on the number of criteria, such as those identified in Table 3 above, that “deliver well”, i.e. achieve specific metrics. For example: a rank of A is assigned if the placement delivers well against four or five of the criteria specified in Table 3; a rank of B is assigned if two or three of the criteria deliver well; and a rank of C is assigned if less than two criteria deliver well.

Placement quality criteria, or simply placement criteria, are used to evaluate the quality of a placement. Placement criteria can only be evaluated after a placement has been produced. In one embodiment, placement quality is ranked similarly to vehicle power. In this embodiment, a rank of premium is assigned if the placement delivers well against four or five of the criteria specified in Table 3; a rank of prominent is assigned if two or three of the criteria deliver well; and a rank of standard is assigned if less than two criteria deliver well.

Duration is ranked based on the duration of a placement. For example, in one embodiment a rank of long is assigned if the placement duration is over 30 seconds, medium is assigned if the placements lasts 10-30 seconds, and short is assigned to placements that last under 10 seconds. As previously discussed, the duration of a placement can typically only be determined and hence a ranking performed after the vehicle that includes a placement has been produced.

In one embodiment, ranking of a placement for vehicle power, placement quality and duration is performed by managers using management application 125 and the values are stored in a database, as described hereinbelow with reference to FIG. 8. In another embodiment, scoring is performed automatically based on opportunity data gathered at step 310 of FIG. 3 and placement results data gathered at step 360 of FIG. 3. For example, automatic scoring may be performed using scene detection, face recognition, pattern recognition, fuzzy logic and other technologies.

At step 520 a price is determined for each placement based on the rankings performed in the preceding step. I one embodiment, price is given in units US dollars per 1000 impressions and is referred to as media value per thousand impressions, or MVM for short. In one embodiment, the price determination, in MVM, is based on the channel, the vehicle power, placement quality of the vehicle, and the duration of the placement. As an example, the MVM for a placement made in a film is selected from a media value matrix such as that depicted in Table 4 below. Table 4 provides a matrix based on the vehicle power and placement quality of a short-duration placement in a film.

TABLE 4
Example Baseline MVM Rate for Film Channel - Short Duration

| Vehicle | Placement Quality | | |
|---|---|---|---|
| Power | Standard | Medium | Prominent |
| A | $8 | $6 | $2 |
| B | $5 | $3.50 | $1.50 |
| C | $2 | $1 | $1 |

The entries in Table 4 are periodically updated based on data from data sources 140 to reflect actual placement rates encountered during the course of executing placement campaigns. In one embodiment, there is one table per channel. In other embodiments there is one table per channel per segment. For example, MVM rates for a film that targets one age group may be higher or lower than MVM rates for a film that targets a different age group. In one embodiment, if a media plan covers multiple segments then the MVM rates may be computed as a weighted average based on the relative importance of each segment to the media buyer.

At step 530 the estimated media value of a placement is then obtained by number of impressions generated by the placement multiplied by the estimated MVM and divided by 1000, as given below in Equation 1:

Media Value(Placement i)=MVM(Placement i)*Impressions(Placement i)/1000 (Equation 1)

At step 540 the estimated placement results, including the impressions and estimated media value for all placements made as part of a corresponding media plan are aggregated, or summed, to obtain the estimated placement results by vehicle, by channel, by segment, etc., for the media plan. The aggregated results may then be displayed with a user interface such those depicted in FIGS. 2E-H.

It may be appreciated by one skilled in the art that the above described method for estimating results may, in an alternative embodiment, be used to project results prior to execution of a campaign, i.e. to perform step 320 of FIG. 3, rather than the simplified method described with reference to FIG. 4 which relies on book rates for conventional media. In this case, hypotheses are made concerning various elements, such as placement quality, vehicle power, duration and number of impressions.

### Determining a Market Value for Placements

In another embodiment, placement service 130 obtains current market advertising rates for comparable conventional advertising for purposes of estimating media value based on rates for comparable conventional advertising rates. As described below in Table 5, for each placement a comparable type of conventional advertising may be used for purposes of comparison. For example, a product placement in a film corresponds to a video advertisement that might be shown prior to the film. Advertising rates, typically available from publishers or sellers of advertising slots, are obtained by placement service 130 in this step. For example, magazines, newspapers, and Web sites typically publish a rate card that gives advertising rates for various types of ads. These can be downloaded directly from the publisher's website.

TABLE 5
Correspondence of Placements with Conventional Advertising

| | Corresponding Conventional |
|---|---|
| Channel | Advertising |
| Film | Video advertisement prior to |
| | showing of film. |
| TV | TV advertisement during |
| | showing of TV program. |
| Music/Songs | Radio or streaming music ad. |
| Web Video | Pre-roll video ad. |
| Web Image | Web image ad. |

In this alternative embodiment, a market value, i.e. the price of purchasing a corresponding conventional media advertisement, for each placement made as part of the placement campaign is computed along with an estimate of the number of impressions that would be generated by such advertising. Placement service 130 then prepares an assessment that directly compares the results of a placement campaign to the results that might be obtained through a conventional advertising campaign. As part of this comparison, estimated media values may be compared to estimates of market values.

FIG. 7 is a system diagram that shows components of one exemplary environment in which the invention may be practiced. Not all of the components may be required to practice the invention, and variations in the arrangement and types of the components may be made without departing from the spirit or scope of the invention. As shown, system 700 of FIG. 7 includes wide area network (“WAN”)/local area network (“LAN”)-(network) 705, wireless network 710, client devices 701-704, and a placement server 706.

Buyer computer 110 and management computer 120 are embodiments of client devices 701-704 which may connect to either or both of wireless network 710 or network 705. Network 150 is an embodiment of wireless network 710, network 705, or a combination of both. Placement server 706 shows one embodiment, or implementation, of placement service 130. Further, data sources 140 are one embodiment of external services 720.

Generally, client devices 701-704 include any computing devices that are capable of receiving and sending messages over a network, such as network 705 or wireless network 710. Client devices 701-704 include personal computers, multiprocessor systems, microprocessor-based or programmable consumer electronics, mobile devices such as mobile telephones, smart phones, display pagers, tablet computers, handheld computers, laptop computers, wearable computers, or the like.

A Web-enabled client device can communicate across the Web. It may include a browser application that is configured to receive and to send web pages, web-based messages, or the like. The browser application may send, receive and display graphics, text, multimedia, or the like, employing a network protocol such as Hypertext Transfer Protocol (HTTP) and/or wireless application protocol (WAP).

Client devices 701-704 may include client application programs that send and receive content to/from other computing devices. Examples of application programs include calendars, browsers and email clients and so forth. Client devices 701-704 may be configured to include an application program that enables a buyer to specify, edit and review a media plan and to view results from a corresponding placement campaign in cooperation with placement server 706. Client devices 701-704 may also be configured to include other application programs used by a media buyer, or management personnel.

Wireless network 710 is configured to couple client devices 702-704 with network 705. Wireless network 710 may include any of a variety of wireless networks that provide a connection for client devices 702-7. Such networks may include mesh networks, wireless LAN (WLAN) networks, cellular networks, or the like. Wireless network 710 may further include network devices such as gateways routers, or the like. In essence, wireless network 710 may include virtually any wireless communication device or mechanism by which enables information to travel between client devices 702-704 and another computing device, network, or the like.

Network 705 is configured to couple placement server 706, and client device 701 with other computing devices, including through wireless network 710 to client devices 702-704. Network 705 may include the Internet in addition to local area networks (LANs), wide area networks (WANs), direct connections, combinations thereof or the like.

Placement server 706 represents one or more network computing devices that are configured to enable a media buyer to interactively specify a media plan, to execute a placement campaign based on the media plan, and to generate results and provide the results to client devices 701-704 for review by the buyer. Placement server 706 is one embodiment of a network device that implements placement service 130.

Devices that may operate as placement server 706 include, but are not limited to personal computers, desktop computers, multiprocessor systems, microprocessor-based or programmable consumer electronics, network PCs, servers, network appliances, and the like.

Although placement server 706 is illustrated as a distinct network device, the invention is not so limited. For example, a plurality of network devices may be configured to perform the functions of placement server 706. One such configuration is a “server farm” that includes multiple server computers operating cooperatively, each performing some of placement server 706 server functions. One embodiment of the software modules that perform placement server 706 server functions is described with reference to FIG. 8 below.

Placement server 706 functions may also be provided by a cloud computing facility in which the services, features and functions ascribed herein to placement server 706 are delivered as a service over a network, such as the Internet, rather than by a specific server or cluster of servers.

Placement server 706 is capable of running application programs (“applications”). Applications that may be run by placement server 706 include transcoders, database programs, customizable user programs, security applications, encryption programs, VPN programs, web servers, applications servers, account management systems, and so forth. Applications run by placement server 706 may also include a buyer interface, a management interface, a database manager, and other applications and processes such as those described below in conjunction with FIG. 8.

Placement server 706 provides web services which include any of a variety of network services that are configured to provide content, including messages, over a network to another computing device. Thus, web services may include an application server, a web server, a messaging server, a File Transfer Protocol (FTP) server, a database server, a content server, or the like. Web services may provide the content including messages over the network using any of a variety of formats, including, but not limited to WAP, HDML, WML, SGML, HTML, XML, cHTML, xHTML, JSON, REST, SOAP or the like. Web services may also include server-side scripting languages such as PHP, Python, and Java servlets. Web services may also include the server side of the Ajax web development method that enables a server to asynchronously respond to Ajax requests.

Placement server 706 includes a computer processor (CPU) and nonvolatile data storage for storing program code and data. Data storage may include virtually any mechanism usable for storing and managing data, including but not limited to a file, a folder, a document, a web page or an application, such as a database, digital media including digital images and digital video clips, and the like.

Data storage may further include a plurality of different data stores. For example, data storage may represent an opportunity database, a user database and other databases such as those described below in conjunction with FIG. 8. Further, data storage may also include network storage or cloud storage in which the physical storage media is accessed across a network.

External services 720 are accessed across network 705/710 from placement server 706. Typically external services 720 is accessed using Web services as previously described. Additionally, external services 720 may provide data through a cloud storage facility that is accessed using protocols such as HTTP and FTP.

FIG. 8 is block diagram of the exemplary software modules of buyer computer 110, management computer 120 and placement server 706.

As discussed above with reference to FIG. 1, a customer interacts with buyer computer 110 via buyer application 115. In a preferred embodiment, buyer application 115 is a Web application, that is it is written using standard Web programming languages such as HTML, JAVASCRIPT, and JAVA, and is executed by a browser 810 that runs in buyer computer 110.

Browser 810 is typically a standard, commercially available, browser such as MOZILLA FIREFOX or MICROSOFT INTERNET EXPLORER. Alternatively, it may also be a client application configured to receive and display graphics, text, multimedia, and the like, across a network.

In one embodiment, when a customer interacts with placement service 130 using buyer application 115, placement service 130 downloads web pages in HTML format to browser 810 for viewing and interactive use. To perform some of the advanced client-side interactive functions the web pages may include client-side scripting instructions from a client-side scripting language. Typically, such client-side scripting instructions are embedded in HTML web pages and are interpreted or executed by a client-side scripting engine to perform functions not available through HTML commands such as advanced graphics, database access, and computations.

Examples of client-side scripting languages include JAVASCRIPT® from ORACLE CORPORATION of Redwood Shores, Calif., the Java open source programming language, ACTIVEX® from the MICROSOFT CORPORATION of Redmond, Wash.

In one embodiment, browser 810 issues hypertext transfer protocol (HTTP) requests to and receives HTTP responses from an application server 820 running in placement service 130.

Application server 820 receives the HTTP requests and invokes the appropriate placement server 706 service to process the request. Application server 820 may be a commercially available application server that includes a web server that accepts and processes HTTP requests transmits HTTP responses back along with optional data contents, which may be web pages such as HTML documents and linked objects (images, or the like). In addition, browser 810 may use Ajax to issue requests for XML or JSON-coded information that is delivered asynchronously by application server 820. Henceforth, the term request message will refer to a message sent by browser 810 using HTTP, Ajax or other client-server communications method to placement server 706. And a response message will refer to a message sent in response, typically using the same communications method, by application server 820 running in placement server 706.

Application server 820 establishes and manages customer and rights holder sessions. Typically application server 820 assigns each session a unique session id. A session lasts from the time a user (i.e. a customer or rights holder) logs in, or accesses placement service 130, until the time the user logs out or stops interacting with placement service 130 for a specified period of time. In addition, application server 820 typically manages server applications and provides database connectivity.

Upon request by browser 810, application server 820 downloads to buyer computer 110 or management computer 120 the HTML, JAVASCRIPT and other browser-executable code that make up buyer application 115 or management application 125, respectively.

In one embodiment, placement server 706 includes the following modules: a buyer interface 822, a management interface 824, a media plan generator 826, a campaign engine 828, a results analyzer 830 and a pricing engine 832. Placement service 130 further includes a data warehouse 834 and five operational databases: a vehicle database 840, an opportunity database 842, a media plan database 844, a user database 846, and a results database 848. It may be appreciated that each of the abovementioned databases may be implemented as one or more computer files spread across one or more physical storage mechanisms. In one embodiment, each of the abovementioned databases is implemented as one or more relational databases and is accessed using the structured query language (SQL).

Data warehouse 834 obtains data from data sources 140 and provides the data in normalized formats to operational databases 840-848. Data warehouse 834 is updated periodically using extract-transform-load (ETL) operations. In one embodiment data warehouse 834 is implemented as a separate server with data storage where the processor performs ETL operations.

Buyer interface 822, management interface 824, media plan generator 826, campaign generator 828, results analyzer 830, and pricing engine 832 may each include, or may share the use of, a commercial database management system (DBMS) to access and search for data and objects that reside in the database. In a preferred embodiment, the DBMS is a relational DBMS (RDBMS) such as ORACLE from the Oracle Corporation, SQL SERVER from the Microsoft Corporation, or the like.

Buyer interface 822 responds to requests from buyer application 115, i.e. it performs the back-end server processing. Buyer interface enables a media buyer to log in to placement service 130, interactively create a media plan and view forecasts and results from the corresponding placement campaign. Buyer interface 822 provides buyer interface screens and data elements to buyer computer 110 and receives data from buyer computer 110. In one embodiment, upon request management interface 722 transmits web pages, scripts and other elements used by buyer application 115 to interactively display buyer interfaces 2A-H to buyer computer 110 for use by buyer application 115.

Management interface 824 responds to requests from management application 125, i.e. it performs the server processing corresponding to the client processing performed by management application 125. Management interface 824 enables a management user to log in to placement service 130, review, add, edit and delete vehicles, opportunities, media plans, and buyer records stored in a user database. In one embodiment, upon request management interface 824 transmits web pages, scripts and other elements used by management application 125 to interactively display management interfaces to buyer computer 110 for use by management application 125.

Media plan generator 826 generates lists of opportunities, consistent with a media plan, for review, filtering and selection by a media buyer using buyer application 115. In some embodiments, media plan generator 826 calculates vehicle power and placement quality of vehicles. Media plan generator 826 stores media plans in media plan database 844.

Campaign engine 828 executes media plans stored in media plan database 844 by purchasing or causing to be purchased placements as indicated in a media plan. Campaign engine 828 maintains an updated status of placements during a placement campaign.

Results analyzer 830 obtains campaign results data from data sources 140 via data warehouse 834 and generates prices, impressions, and other results data. Results analyzer 830 stores results data in results database 848. Results analyzer 830 relies on pricing engine 832 to perform results forecasts such as price and impressions and to determine media values and, in some embodiments, market values of placements.

Pricing engine 832 forecasts results and determines results of placement campaigns. Among its various functions, pricing engine 832 performs the methods described with reference to FIGS. 4 and 5. Pricing engine 832 stores results data in results database 848.

In the discussion hereinbelow concerning databases it may be appreciated by one skilled in the art that each database may be implemented as one or more database files, alternatively two or more of the databases may be implemented as a single database file. Further the term database may refer to a relational database file that is accessed by a relational database manager or it may implemented as a B-tree, R-tree, spreadsheet, flat file, comma separated value any other type of suitable data structure stored within one or more computer files.

Vehicle database 840 stores records for each vehicle in which a placement may be made. The records typically include metadata that describe properties of the vehicle such as the producer or director, artists, owner, contact information, and vehicle power.

Opportunity database 842 stores records for each placement opportunity. The records typically include metadata that describe properties of the opportunity such as the vehicle in which the opportunity occurs, the start and end point, the duration, a description of the scene, which actors are present, and the like.

Media plan database 844 stores records for each media plan prepared or being prepared by a buyer. The records typically include metadata that describe properties of the media plan such as descriptive information provided by the buyer using buyer interface 200, target channel mix, opportunities selected for inclusion and exclusion, filters and other information captured using buyer interfaces 210 and 220, and opportunities to be included in the media plan.

User database 846 stores a record for each buyer, management or other user of placement service 130. Each user record includes information such as name and contact information, username and password. Buyer records may include information about buyer preferences.

Results database 848 stores results from placement campaigns, typically generated by results analyzer 830 and pricing engine 832. Results database may include price information such as market rates for conventional advertising, and price tables to be used for forecasting placement prices. Results database 832 may also include historical information and information obtained from data sources 140.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for product placements within media, comprising:
maintaining by a placement server a database of placement opportunities wherein a placement is a visible display of a product that is included in a media vehicle and wherein said placement is integrated into the media vehicle during production of the media vehicle;
receiving from a buyer computer a media plan by a buyer, said media plan specifying a plurality of desired placements to purchase and a budget to be used to purchase placements from the plurality of desired placements;
projecting, by the placement server, the number of impressions the purchased placements will generate;
initiating execution of the media plan wherein execution comprises purchasing at least one of the desired placements;
gathering data about the results of each of the purchased placements, said results data comprising a number of impressions for the media vehicle that includes the placement;
evaluating each purchased placement relative to a plurality of placement criteria to determine a placement quality ranking, wherein placement criteria can only be evaluated after production of the vehicle that includes the placement;
estimating a media value for each placement based on the assessed placement quality ranking for the placement;
aggregating the estimated media value and the gathered impressions for all purchased placements; and
halting execution of the media plan when the aggregate estimated media value exceeds the budget and the aggregate number of impressions exceeds the projected number of impressions.

2. The method of claim 1 wherein at least one of the placement criteria is selected from group consisting of whether the product is used in the vehicle, whether the product is clearly visible, if there is a verbal mention of the product, if there is an implied celebrity endorsement of the product and if the product is integrated with the storyline.

3. The method of claim 1 wherein gathering data further includes gathering data about each vehicle in which a placement is made, the method further comprising:
evaluating each vehicle in which a placement is purchased relative to a plurality of vehicle criteria to determine a vehicle power ranking for each placement wherein the vehicle criteria include at least one member from the group consisting of viewership, cast and director, network, timeslot, demographics, buzz, brand appropriateness and heat index;
and wherein said estimating a media value for each placement is further based on the vehicle power ranking.

4. The method of claim 1 wherein said estimating a media value for a placement is further based on the duration of the produced placement and wherein the duration can only be determined after production of the vehicle that includes the placement.

5. The method of claim 1 wherein said estimating a media value for a placement is further based the gathered number of impressions for the vehicle in which the placement was made.

6. The method of claim 1 further comprising executing the media plan by making placements as specified by the media plan.

7. The method of claim 1 further comprising providing the aggregated media value and impressions for the media plan to the buyer computer for display to a media buyer.

8. The method of claim 1 wherein each media vehicle corresponds to a media channel and said media channels are selected from the group consisting film, television, recorded music, celebrity photos, and Web videos.

9. The method of claim 1 wherein said media plan specification further includes a specification of at least one target market segment.

10. The method of claim 1 wherein said media plan specification further includes an indication of at least one preferred program to guide selection of placement opportunities for inclusion in the media plan.

11. The method of claim 1 wherein said media plan specification further includes an indication of at least one placement opportunity to exclude from the media plan.

12. A server computer, comprising:
a processor;
a communication interface in communication with the processor;
a data storage for storing a database of placement opportunities wherein a placement is a visible display of a product that is included in a media vehicle and wherein said placement is integrated into the media vehicle during production of the media vehicle;
a memory in communication with the processor for storing instructions, which when executed by the processor, cause the server:
to receive from a buyer computer a media plan, said media plan specifying a plurality of desired placements to purchase and a budget to be used to purchase placements from the plurality of desired placements;
to project the number of impressions the purchased placements will generate;
to initiate execution of the media plan wherein execution comprises purchasing at least one of the desired placements;
to gather data about the results of each of the purchased placements, said results data comprising a number of impressions for the media vehicle that includes the placement;
to evaluate each purchased placement relative to a plurality of placement criteria to determine a placement quality ranking, wherein placement criteria can only be evaluated after production of the vehicle that includes the placement;
to estimate a media value for each placement based on the assessed placement quality ranking for the placement;
to aggregate the estimated media value and the gathered impressions for all purchased placements; and
to haft execution of the media plan when the aggregate estimated media value exceeds the budget and the aggregate number of impressions exceeds the projected number of impressions.

13. The server computer of claim 12 wherein at least one of the placement criteria is selected from group consisting of whether the product is used in the vehicle, whether the product is clearly visible, if there is a verbal mention of the product, if there is an implied celebrity endorsement of the product and if the product is integrated with the storyline.

14. The server computer of claim 12 wherein gathering data further includes gathering data about each vehicle in which a placement is made, wherein the instructions, when executed by the processor, further cause the server:
to evaluate each vehicle in which a placement is purchased relative to a plurality of vehicle criteria to determine a vehicle power ranking for each placement wherein the vehicle criteria include at least one member from the group consisting of viewership, cast and director, network, timeslot, demographics, buzz, brand appropriateness and heat index;
and wherein said estimating a media value for each placement is further based on the vehicle power ranking.

15. The server computer of claim 12 wherein said estimating a media value for a placement is further based on the duration of the produced placement and wherein the duration can only be determined after production of the vehicle that includes the placement.

16. The server computer of claim 12 wherein said estimating a media value for a placement is further based the gathered number of impressions for the vehicle in which the placement was made.

17. The server computer of claim 12 wherein the instructions, when executed by the processor, further cause the server to execute the media plan by making placements as specified by the media plan.

18. The server computer of claim 12 wherein the instructions, when executed by the processor, further cause the server to provide the aggregated media value and impressions for the media plan to the buyer computer for display to a media buyer.

19. The server computer of claim 12 wherein each media vehicle corresponds to a media channel and said media channels are selected from the group consisting film, television, recorded music, celebrity photos, and Web videos.

20. The server computer of claim 12 wherein said media plan specification further includes a specification of at least one target market segment.

21. The server computer of claim 12 wherein said media plan specification further includes an indication of at least one preferred program to guide selection of placement opportunities for inclusion in the media plan.

22. The server computer of claim 12 wherein said media plan specification further includes an indication of at least one placement opportunity to exclude from the media plan.
